(19) United States
(12) Patent Application Publication
(10) Pub. No.: US 2012/0274235 A1
(43) Pub. Date: Nov. 1, 2012

(54) Power Converting Circuit and Converting Controller

(75) Inventors: Li-Min LEE, New Taipei City (TW); Chung-Che YU, New Taipei City (TW); Shian-Sung SHIU, New Taipei City (TW); Xi TU, Wuxi (CN)

(73) Assignee: GREEN SOLUTION TECHNOLOGY CO., LTD., New Taipei City (TW)

(21) Appl. No.: 13/241,296

(22) Filed: Sep. 23, 2011

(30) Foreign Application Priority Data
Apr. 26, 2011 (CN) 201110114201.0

(51) Int. Cl. H05B 37/02; G05F 1/00

(52) U.S. Cl. 315/297; 323/271

(57) ABSTRACT

A converting controller, adapted to control a converting circuit to convert an electric power from an input power source, is provided. The controller comprises a duty cycle control unit, a protection enabling control unit and a protection unit. The duty cycle control unit controls the converting circuit according to a feedback signal for converting the electric power from the input power. The protection enabling control unit outputs protection enabling signals according to time results of a timing circuit. The protection unit detects the converting circuit and generates a protection signal when any circuit error is determined, so as to stop the duty cycle control unit, wherein the protection unit has a plurality of protection functions and enables the protection functions with respect to the protection enabling signals, respectively.

### RELATED APPLICATIONS

This application claims priority to China Application Serial Number 201110114201.0, filed Apr. 26, 2011, which is herein incorporated by reference.

### BACKGROUND OF THE INVENTION

(1) Field of the Invention

This invention relates to a power converting circuit and a converting controller thereof, and more particularly relates to a power converting circuit with protection functions and a converting controller thereof.

(2) Description of the Prior Art

The current power converting circuits are mainly divided into two types, a linear power supply and a switching power supply. The linear power supply features a simpler circuit and exhibits low ripple and noise. However, the linear power supply is physically large in size and heavy in weight because of the big electronic units therein. In addition, the linear power supply also has a drawback of low conversion efficiency. In contrast, although the switching power supply is more complicated in circuits and exhibits larger ripple and noise, yet it still has the advantages of high conversion efficiency and low loss under no-load condition. Thus, the switching power supply is still the main trend on the market of power converting circuit.

The main function of power converting circuit is to convert an input power into an adequate power for driving the load. To prevent the circuit abnormal condition from damaging the electronic units or even injuring the user, the power converting circuit will stop supplying power to the load when the abnormal condition is detected. However, just right after the power converting circuit is started-up, the driving power generated by the power converting circuit is not stable yet and thus the condition of circuit may be wrongly judged. To solve this problem, a typical method is to temporarily stop the protection function within a predetermined time period after the power converting circuit has been activated.

The protection functions available in the current converting circuit include an over-voltage protection, an under-voltage protection and an over-current protection, etc. To make sure that the predetermined time period is long enough to avoid misjudges, the enabling time point at which the last protection function is enabled is utilized as a reference time so as to activate various protection functions altogether. However, such a method may delay the activation of other protection functions, such that a harmful defect for circuit protection will be generated.

### SUMMARY OF THE INVENTION

According to the harmful defect due to one single protection enabling time used for activating the protection functions altogether, the present invention activates protection functions according to a predetermined time sequence so as to adequately activate different protection functions for minimizing the aforementioned defect.

For achieving the aforementioned objects, a converting controller for controlling a converting circuit to convert a power from an input power source is provided. The converting controller includes a duty cycle control unit, a protection enabling control unit, and a protection unit. The duty cycle control unit is utilized for controlling the converting circuit to conduct a conversion operation according to a feedback signal. The protection enabling control unit outputs a plurality of protection enabling signals according to a counting result from a timing circuit. The protection unit is utilized for detecting the converting circuit and generating a protection signal to terminate the operation of the duty cycle control unit when an abnormal condition occurring in the converting circuit is determined. The protection unit has a plurality of protection functions which are enabled according to the corresponding protection enabling signals.

The present invention also provides a power converting circuit including a converting circuit and a converting controller. The converting circuit is coupled to an input power source for converting a power from the input power source so as to drive a load. The converting controller is utilized for controlling the converting circuit to conduct a conversion operation according to a feedback signal. When an abnormal condition occurring in the converting circuit or the load is determined, the converting controller activates a corresponding one among a plurality of protection functions so as to stop the conversion operation. The converting controller enables the protection functions in a predetermined protection enabling sequence according to an enabling signal.

### BRIEF DESCRIPTION OF THE DRAWINGS

The present invention will now be specified with reference to its preferred embodiment illustrated in the drawings, in which:

FIG. 1 is a schematic circuit diagram of a protection enabling control unit in accordance with a first preferred embodiment of the present invention applied in a converting controller;

FIG. 2 is a timing diagram showing the signals corresponding to the embodiment of FIG. 1;

FIG. 3 is a schematic circuit diagram of a power converting circuit in accordance with a first embodiment of the present invention;

FIG. 4 is a schematic circuit diagram of a power converting circuit in accordance with a second embodiment of the present invention; and

FIG. 5 is a schematic circuit diagram of a protection enabling control unit in accordance with a second preferred embodiment of the present invention applied in a converting controller.

### DESCRIPTION OF THE PREFERRED EMBODIMENT

FIG. 1 is a schematic circuit diagram of a protection enabling control unit in accordance with a first preferred embodiment of the present invention applied to a converting controller. The protection enabling control unit 100 includes a timing circuit which has a capacitor C, a charging circuit 105 and a counting comparison circuit 110. The charging circuit 105 includes a first charging current source I1, a second charging current source I2, and a charging current adjusting switch SW. The counting comparison circuit 110 includes comparators 112, 114 and 116. The non-inverting inputs of the three comparators 112, 114 and 116 are coupled to the capacitor C, and the inverting inputs thereof respectively receives reference signals V1, V2 and V3, wherein the level of the reference signal V1 is lower than that of the reference signal V2, and the level of the reference signal V2 is lower than that of the reference signal V3. The protection enabling control unit 100 also includes a reset unit (not labeled), which receives an under-voltage lockout protection signal UVLO, an enabling signal EN, and a protection signal PROT for deciding a start counting time of the protection enabling control unit 100. The reset unit includes an NAND gate 124 and a reset switch SWre. When reset is performed, the capacitor C is discharged to back to a zero level for refreshing the timing circuit. In the present embodiment, the NAND gate 124 may turn on the reset switch SWre to refresh the timing circuit as any one of the conditions including the converting controller failing to be enabled (the enabling signal EN is at a low level), the driving voltage received by the converting controller failing to be high enough (the under-voltage lockout signal UVLO is at a low), and an abnormal circuit (the protection signal PROT is at a low or high level) occurs. Thus, the protection enabling control unit 100 decides the start counting time according to the enabling signal EN, etc., and the protection enabling control unit 100 may be restarted when the driving voltage is insufficient or any abnormal condition occurring in the circuit.

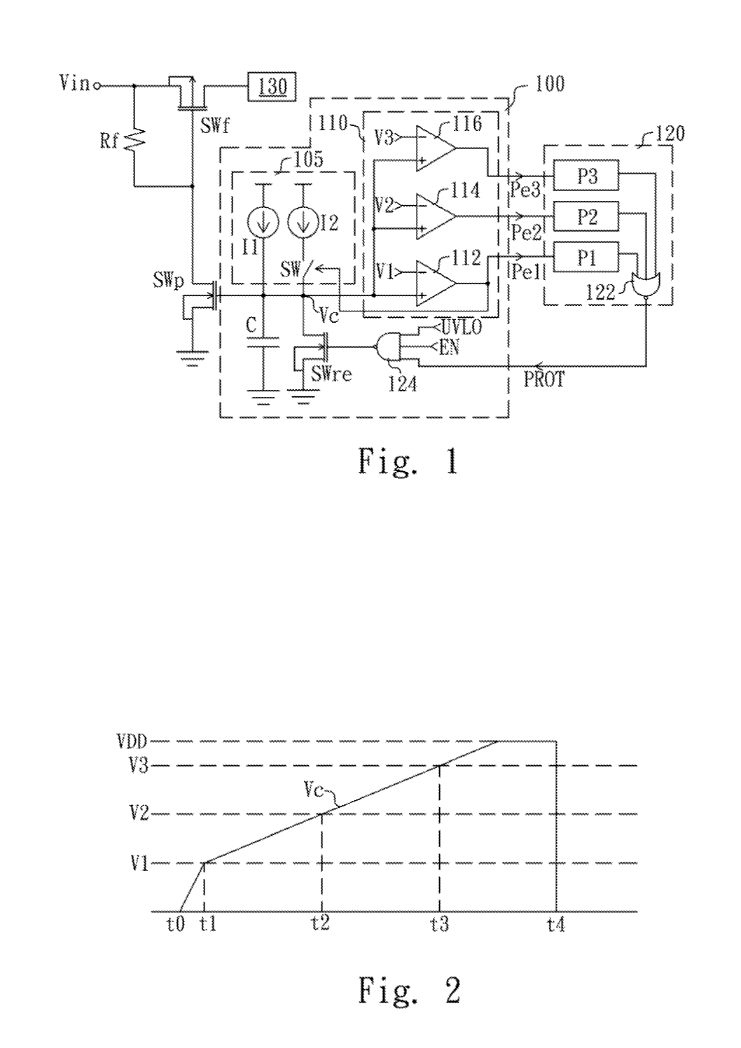

FIG. 2 is a timing diagram showing the signals corresponding to the embodiment of FIG. 1. As shown in FIG. 2, when the reset switch SWre is turned off at time point t0, the voltage level Vc of the capacitor C starts rising to make the comparators 112, 114 and 116 output high level protection enabling signals Pe1, Pe2 and Pe3 at time points t1, t2 and t3 respectively, thereby enabling the corresponding protection function circuits P1, P2 and P3 within a protection unit 120. These protection function circuits may be an over voltage protection circuit, an under voltage protection circuit, an over current protection circuit, an under current protection circuit and an over temperature protection circuit, etc. At time point t4, as any one of the enabled protection function circuits P1, P2 and P3 in the protection unit 120 detects an abnormal condition occurring in the detected circuit, a low level protection signal PROT is outputted from the NOR gate 122 to make the converting controller enter the protection state. Meanwhile, the reset unit discharges the capacitor C to make the voltage level Vc back to zero. An abnormal condition may be detected by an enabled protection function circuit before the time point t4, the protection unit 120 could still output the low level protection signal PROT to make the converting controller enter the protection state.

The protection enabling control unit 100 also may be utilized to control an input switch SWf for deciding whether the power from the input power source Vin is stopped from being continuously imputed to the converting circuit 130 which is controlled by the converting controller. Therefore, the protection enabling control unit 100 is capable of stopping power transmission from the input power source Vin to the converting circuit 130 so as to prevent electronic units in the circuit from being damaged under the abnormal conditions. The input switch SWf is coupled between the input power source Vin and the converting circuit 130, and a protection switch SWp and a protection resistor Rf is connected in series between the input power source Vin and a ground. A junction between the protection switch SWp and the protection resistor Rf is coupled to the control end of the input switch SWf. When the voltage level Vc of the capacitor C in the protection enabling control unit 100 is back to zero, the protection switch SWp will be turned off. Then, the level of the junction between the protection switch SWp and the protection resistor Rf will be increased to the level equal to the input power source Vin, such that the input switch SWf will be turned off to stop the power transmitted from the input power source Vin to the converting circuit 130.

The enabling sequence of the protection functions may be determined according to the condition of actual circuit design. In general, the protection for the circuit disposed closer to the input power source Vin should be activated earlier than the circuit disposed farther away from the input power source Vin, and the protection for current should be activated prior to the protection for voltage, and the protection for the weak electronic element should be activated prior to the protection for the strong one. The designer may determine an adequate protection enabling sequence according to the actual circuit design, and the protection enabling control unit of the present invention may activate the protection functions in the predetermined protection enabling sequence.

The levels of the reference signals V1, V2 and V3 and the setting of charging current of the charging circuit 105 may be utilized for deciding the protection enabling time of the protection function circuits P1, P2 and P3 in the protection unit 120. In addition, under the limitation of the detectable level range of the comparator due to noise, the timing circuit may encounter the difficulty in counting time period when the voltage level Vc of the capacitor C is close to the ground level or to a driving voltage level of the comparator. Thus, the charging circuit 105 may adjust the amount of the charging current according to the protection enabling signal from the counting comparison circuit 110 for obtaining a shorter or a longer counting time period. In the present embodiment, in the time period between time points t0 to t1, the charging circuit 105 charges the capacitor C by using the charging currents from the first current source I1 and the second current source I2 simultaneously, to make the voltage level Vc of the capacitor C reach the level of the reference signal V1 quickly, thus enabling the comparator 112 to output the high level protection enabling signal Pe1. The high level protection enabling signal Pe1 also turns off the charging current adjusting switch SW, such that the charging circuit 105 charges the capacitor C merely by using the charging current from the first current source I1 after the high level protection enabling signal Pe1 is generated. In addition to the voltage level of the capacitor, the timing circuit may decide the enabling time of the protection functions by using the typical counting means such as counting the number of pulses generated by a clock generator. Besides, the aforementioned charging operation is similar to the typical soft-start operation, which increases the duty cycle by charging the capacitor. Thus, the aforementioned two circuits can be integrated as described below.

FIG. 3 is a schematic circuit diagram of the power converting circuit in accordance with a first embodiment of the present invention. The power converting circuit includes a converting circuit 230 and a converting controller 250. The converting circuit 230 is coupled to an input power source Vin for converting the power to drive a load 235. The converting controller 250 controls the converting circuit 230 to conduct a conversion operation according to a feedback signal VFB representing a state of the load 235. In the present embodiment, the converting circuit 230 is a DC-to-DC buck converting circuit, which includes a first switch SW1, a second switch SW2, an inductor L and an output capacitor Co. The converting controller 250 controls the on/off states of the first switch SW1 and the second switch SW2 according to the feedback signal VFB generated by a voltage detecting circuit VD, so as to convert the voltage level of the input power source Vin into a stable output voltage Vout to drive the load 235.

The converting controller 250 includes a protection enabling control unit 200, a soft-start circuit 205, a protection unit 220, and a duty cycle control unit 240. The soft-start circuit 205 generates a soft-start signal SS after receiving the enabling signal EN. The duty cycle control unit 240 receives the soft-start signal SS and conducts a soft-start operation according to the soft-start signal SS to gradually increase the duty cycle of the first switch SW1. Thus, the ripple generated by the suddenly increased duty cycle just after the beginning of the start-up period can be reduced. The protection enabling control unit 200 decides the time to start counting time according to the enabling signal EN and outputs a plurality of protection enabling signals Pe to the protection unit 220 according to the predetermined protection enabling sequence, so as to activate the corresponding protection functions in a sequence. In the present embodiment, the sort-start signal SS has an increasing voltage level with time, which may be utilized to replace the voltage level Vc in FIG. 1 as basis for the counting time of the protection enabling control unit 200. The protection unit 220 detects the condition of the circuit and generates a protection signal PROT to stop the operation of the duty cycle control unit 240 when it is determined that an abnormal condition occurs in the converting circuit or the load. In the present embodiment, the protection unit 220 determines whether the level of the output voltage is too high or too low; whether the load current lload is too large or too small; and whether the input current is too large or too small, according to the feedback signal VFB, the load current signal Ise, and the current detecting signal Cse, and the protection unit 220 generates and outputs the protection signal PROT to the duty cycle control unit 240 for forcing the converting controller 250 to enter the protection mode for stopping the conversion operation of the converting circuit 230, as any of the aforementioned abnormal conditions occurs or continues for a predetermined time period. The protection signal PROT is also fed into the protection enabling control unit 200 to reset the time counting of the protection enabling control unit 200.

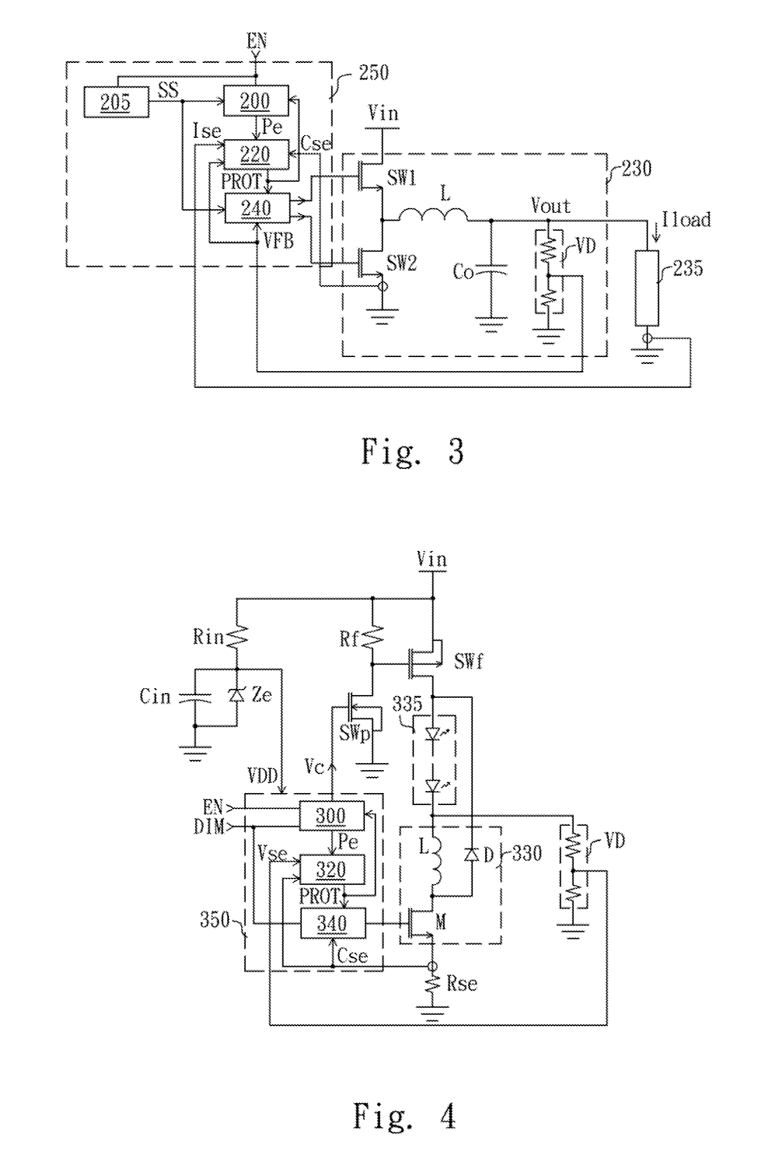

FIG. 4 is a schematic circuit diagram of a power converting circuit in accordance with a second embodiment of the present invention. The power converting circuit includes a converting circuit 330 and a converting controller 350, and is utilized to convert the power from an input power source Vin to drive a load 335. In the present embodiment, the load 335 is an LED (Light-Emitting diode) module.

The converting controller 350 controls the converting circuit 330 for conducting a conversion operation according to a current detecting signal Cse representing the condition of current on the load. That is, the current detecting signal Cse is utilized for feedback control. In the present embodiment, the converting circuit 330 includes a switch M, an inductor L, and a diode D. A current detecting resistor Rse is coupled to the switch M for generating the current detecting signal Cse according to the current flowing through the load 335. A voltage detecting circuit VD is coupled to the negative end of the load 335 for generating a voltage detecting signal Vse according to the voltage drop across the load 335. In addition, an input switch SWf is coupled between the input power source Vin and the converting circuit 330, and a protection switch SWp and a protection resistor Rf are coupled in series between the input power source Vin and a ground. The junction between the protection switch SWp and the protection resistor Rf is coupled to the control end of the input switch SWf. As the converting controller 350 determines that an abnormal condition occurs in the circuit, the converting controller 350 may cut off the input switch SWf via the protection switch SWp and the protection resistor Rf, so as to stop the transmission of power to the converting circuit for achieving the object of protecting the converting circuit 330 and the load 335. The power for driving the converting controller 350 is not influenced by the condition of the input switch SWf. The power for driving the converting controller 350 is provided by a driving voltage circuit including an input resistor Rin, an input capacitor Cin, and a zener diode Ze, which is coupled to the input power source Vin for providing a driving voltage VDD.

The converting controller 350 includes a protection enabling control unit 300, a protection unit 320, and a duty cycle control unit 340. The duty cycle control unit 340 detects the current flowing through the load 335 according to the current detecting signal Cse, and turns off the switch M as the current flowing through the load 335 reaches an upper limit. The switch M will be turned on again after a constant off time so as to make the current flowing through the load 335 stay within a predetermined range. The duty cycle control unit 340 also performs burst dimming onto the load 335 according to a dimming signal DIM.

The protection enabling control unit 300 decides the timing to start counting time according to the enabling signal EN and the dimming signal DIM, and outputs a plurality of protection enabling signals Pe to the protection unit 320 for enabling the corresponding protection functions provided by the protection unit 320 according to the predetermined protection enabling sequence. In the present embodiment, the protection enabling control unit 300 restarts time counting when the dimming signal indicates “ON”, and the protection enabling control unit 300 stops the protection functions from the protection unit 320 when the dimming signal indicates “OFF”, thereby preventing the condition at which the dimming signal indicates “OFF” from being determined as an abnormal condition.

The protection unit 320 detects the condition of the circuit, and generates a protection signal PROT to stop the operation of the duty cycle control unit 340 when it is determined that an abnormal condition occurs in the converting circuit 330 or the load 335. In the present embodiment, the protection unit 320 determines whether the number of short-circuited LED units is too many or the load current is too large according to the voltage detecting signal Vse and the current detecting signal Cse respectively, and generates and outputs the protection signal PROT to the duty cycle control unit 340 for forcing the converting controller to enter the protection mode for stopping the conversion operation of the converting circuit 330, as any one of the aforementioned abnormal conditions occurs or continues for a predetermined time period. The protection signal PROT is also fed into the protection enabling control unit 300 to reset the time counting of the protection enabling control unit 300.

The aforementioned embodiment activates the protection functions according to the predetermined enabling sequence. These protection functions may be enabled one by one or several protection functions may be enabled at the same time. In addition, the present invention also has the capability of determining if any protection function can be enabled in advance for a better protection.

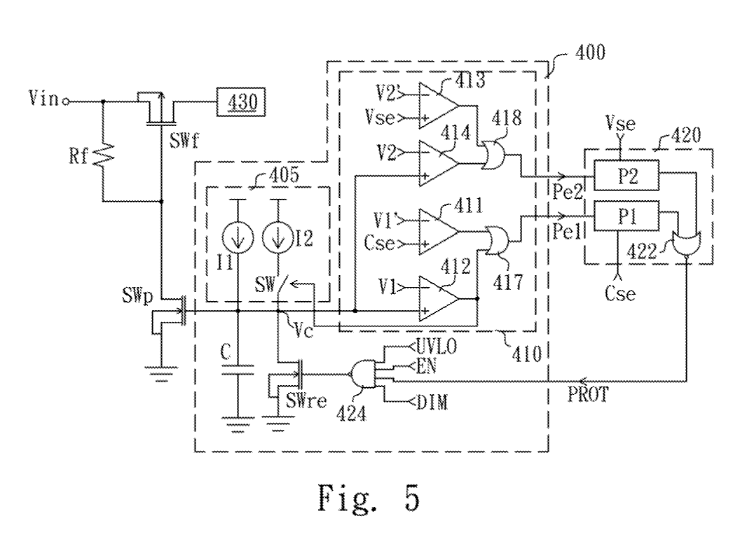

FIG. 5 is a schematic circuit diagram of a protection enabling control unit in accordance with a second preferred embodiment applied in a converting controller. The protection enabling control unit 400 includes a capacitor C, a charging circuit, and a counting comparison circuit 410. The charging circuit 405 includes a first charging current source I1, a second charging current source I2, and a charging current adjusting switch SW. The counting comparison circuit 410 includes comparators 411, 412, 413, 414 and OR gates 417 and 418. The non-inverting inputs of the comparators 412 and 414 are coupled to the capacitor C, and the inverting inputs receive the reference signals V1 and V2 respectively, wherein the level of the reference signal V1 is lower than that of the reference signal V2. The non-inverting input of the comparator 411 receives the current detecting signal Cse, and the inverting input thereof receives the reference signal V1′. The non-inverting input of the comparator 413 receives the voltage detecting signal Vse, and the inverting input thereof receives the reference signal V2′. The OR gate 417 receives the output signals of the comparators 411, 412 so as to output a protection enabling signal Pe1 to the protection function circuit P1 of the protection unit 420. The OR gate 418 receives the output signals from the comparators 413 and 414, and outputs a protection enabling signal Pe2 to the protection function circuit P2 of the protection unit 420. The protection enabling control unit 400 includes a reset unit, which receives an under-voltage lockout signal, an enabling signal EN, a dimming signal DIM, and a protection signal PROT for deciding the timing of starting counting time. The reset unit includes an NAND gate 424 and a reset switch SWre. When a reset operation is performed, the capacitor C is discharged to make the voltage level Vc on the capacitor C back to zero for the purpose to restart time counting. The protection enabling control unit 400 may control an input switch SWf via a protection switch SWp and a protection resistor Rf coupled in series between the input power source Vin and a ground, and turn off the input switch SWf to stop the transmission of power from the input power source Vin to the converting circuit 430 when an abnormal condition occurs.

The protection function circuit P1 receives the current detecting signal Cse to determine whether an abnormal condition occurs in the current represented by the current detecting signal Cse. When the current reaches a predetermined value represented by the reference signal V1′, the current is then detectable. Thus, the OR gate 417 may generate the protection enabling signal Pe1 to activate the protection function circuit P1 according to the high level signal outputted by the comparator 411 even when the output of the comparator 412 is low. For the same reason, the protection function circuit P2 receives the voltage detecting signal Vse to determine whether an abnormal condition occurs in the voltage represented by the voltage detecting signal Vse. When the voltage level reaches a predetermined value represented by the reference signal V2′, the voltage level is then detectable. Thus, the OR gate 418 may generate the protection enabling signal Pe2 to activate the protection function circuit P2 according to the high level signal outputted by the comparator 413 even when the output of the comparator 414 is low.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

What is claimed is:

1. A converting controller for controlling a converting circuit to convert a power from an input power source, the converting controller comprising:
a duty cycle control unit utilized for controlling the converting circuit to conduct a conversion operation according to a feedback signal;
a protection enabling control unit utilized for outputting a plurality of protection enabling signals according to a counting result from a timing circuit; and
a protection unit utilized for detecting the converting circuit and generating a protection signal to terminate an operation of the duty cycle control unit when an abnormal condition occurring in the converting circuit is determined, and the protection unit having a plurality of protection functions which are enabled according to the responded protection enabling signals.

2. The converting controller of claim 1, wherein the timing circuit starts counting time according to an enabling signal, a dimming signal, at least one of the protection signals, or a combination thereof.

3. The converting controller of claim 2, wherein the timing circuit includes a capacitor, a charging circuit, and a counting comparison circuit, wherein the charging circuit charges the capacitor by using a charging current after the timing circuit starts counting time, and the counting comparison circuit generates the protection enabling signals according to a voltage level of the capacitor.

4. The converting controller of claim 3, wherein the charging circuit adjusts an amount of the charging current according to at least one of the protection enabling signals.

5. The converting controller of claim 1, wherein the timing circuit is a soft-start circuit for generating a soft-start signal, and the duty cycle control unit conducts a soft-start operation according to the soft-start signal.

6. The converting controller of claim 1, wherein the protection enabling control unit decides whether to early output a corresponding protection enabling signal among the protection enabling signals according to at least one detecting signal.

7. A power converting circuit, comprising:
a converting circuit coupled to an input power source for converting a power from the input power source to drive a load; and
a converting controller for controlling the converting circuit to conduct a conversion operation according to a feedback signal, wherein when an abnormal condition occurring in the converting circuit or the load is determined, a corresponding one among a plurality of protection functions is enabled to stop the conversion operation;
wherein the converting enables the protection functions in a predetermined protection enabling sequence according to an enabling signal.

8. The power converting circuit of claim 7, further comprising:
an input control switch coupled to the input power source and the converting circuit, wherein the converting controllers controls the input control switch to de-couple the input power source and the converting circuit when the abnormal condition occurring in the converting circuit or the load is determined.

9. The power converting circuit of claim 7, further comprising:
a driving circuit coupled to the input power source for generating a driving voltage as a demanded power for operating the converting controller.

10. The power converting circuit of claim 8, further comprising:
a driving circuit coupled to the input power source for generating a driving voltage as a demanded power for operating the converting controller.

11. The power converting circuit of claim 7, wherein the load includes at least one LED, and the converting controller conducts a burst dimming procedure onto the LED according to a dimming signal and activates the protection functions in the predetermined enabling sequence according to the dimming signal.

12. The power converting circuit of claim 7, wherein the converting controller includes a timing circuit for counting time, and the converting controller activates the protection functions according to a counting result of the timing circuit.

13. The power converting circuit of claim 12, wherein the converting controller decides whether to activate the corresponding protection function among the protection functions in advance according to at least one detecting signal.
